(19) United States
(12) Patent Application Publication
(10) Pub. No.: US 2014/0069014 A1
(43) Pub. Date: Mar. 13, 2014

(54) SAFETY APPARATUS OF AUTOMATIC DOOR

(71) Applicant: HYUNDAI MOTOR COMPANY, Seoul (KR)

(72) Inventor: Wan Lee, Wanju-gun (KR)

(73) Assignee: Hyundai Motor Company, Seoul (KR)

(21) Appl. No.: 13/673,787

(22) Filed: Nov. 9, 2012

(30) Foreign Application Priority Data
Sep. 10, 2012 (KR) 10-2012-0100109

(51) Int. Cl. E05F 15/00; E05D 15/06; E05F 5/00

(52) U.S. Cl. CPC E05F 15/0013; E05F 5/003; E05D 15/0621
USPC 49/27; 49/26; 49/404

(57) ABSTRACT

A safety apparatus of an automatic door may include a body mounted with an entrance, a door slidably mounted on the body and opening or closing the entrance, and a safety device including a safety part slidably mounted at a side of the door and an elastic part mounted at the side of the door to elastically support the safety part, wherein the safety part may be slidably mounted on an upper portion and a lower portion of the side of the door, respectively, and includes upper and lower moving members slidably mounted on the side of the door and elastically supported by the elastic part, and a rotating member rotatably mounted between the upper and lower moving members.

### CROSS-REFERENCE TO RELATED APPLICATION

The present application claims priority to Korean Patent Application No. 10-2012-0100109, filed on Sep. 10, 2012, the entire contents of which is incorporated herein for all purposes by this reference.

### BACKGROUND OF THE INVENTION

1. Field of the invention

The present invention relates to a safety apparatus of an automatic door of a bus, and more particularly, to a safety apparatus of an automatic door capable of preventing an accident from occurring due to a passenger caught in between a door and a vehicle body in a state in which a door is closed.

2. Description of Related Art

In the related art, an automatic door of a bus is automatically opened or closed by a driver's operation and when a passenger is in front of the automatic door of a bus, an alarm sound is generated so that the automatic door is not closed.

Further, after the automatic door of a bus is somewhat closed, the automatic door is forcibly closed so as to prevent an automatic door from being opened while driving a bus. In this case, when the door is closed at the time of a passenger getting off in haste, a passenger may be hurt due to articles carried by a passenger are sandwiched in the door.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a safety apparatus of an automatic door capable of preventing an accident occurring due to a sandwiched passenger in a state in which a door is closed.

In an aspect of the present invention, a safety apparatus of an automatic door may include a body mounted with an entrance, a door slidably mounted on the body and opening or closing the entrance, and a safety device including a safety part slidably mounted at a side of the door and an elastic part mounted at the side of the door to elastically support the safety part, wherein the safety part is slidably mounted on an upper portion and a lower portion of the side of the door, respectively, and may include upper and lower moving members slidably mounted on the side of the door and elastically supported by the elastic part, and a rotating member rotatably mounted between the upper and lower moving members.

The rotating member is formed of a cylindrical shape.

The rotating member is made of a synthetic resin having a buffer power.

The safety device may further include a return switch sensing a sliding movement of the safety part to again open the door when the sliding movement of the safety part is sensed.

In another aspect of the present invention, a safety apparatus of an automatic door may include a body mounted with an entrance, a door slidably mounted on the entrance of the body and opening or closing the entrance, and a safety device including a hinge member rotatably hinged to a side of the door contacting the body, and a contact member fixed to the hinge member and configured to contact the body.

The safety device may further include an elastic part mounted on the hinge member and the door and elastically supporting the hinge member against a pivotal direction of the hinge member.

The contact member is formed outside the entrance further than the hinge member.

The entrance of the body is provided with a support part that supports the safety part to prevent the safety part from rotating inwardly from the entrance.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a perspective view illustrating a safety apparatus of an automatic door according to an exemplary embodiment of the present invention.

FIG. 2 is a partial enlarged view of the safety apparatus of the automatic door according to the exemplary embodiment of the present invention.

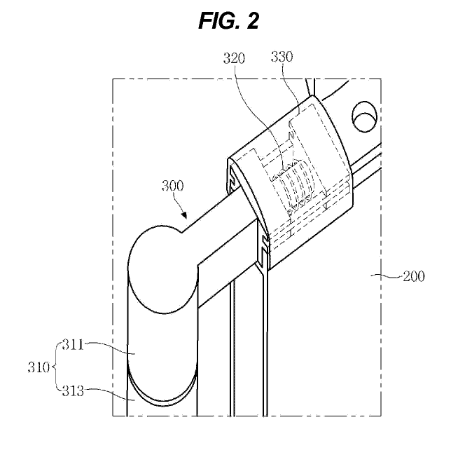

FIG. 3 is a partially exploded perspective view of the safety apparatus of the automatic door according to the exemplary embodiment of the present invention.

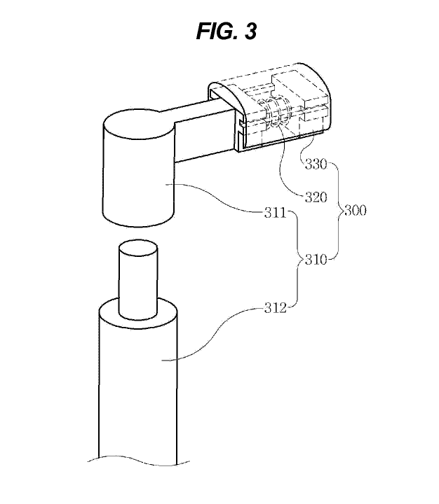

FIG. 4 is a perspective view illustrating a safety apparatus of an automatic door according to another exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

A safety apparatus of an automatic door according to an exemplary embodiment of the present invention includes a safety device that is slidably moved or rotated at a side portion of a door to prevent beforehand an accident from occurring due to a passenger caught between a body of a vehicle and a door.

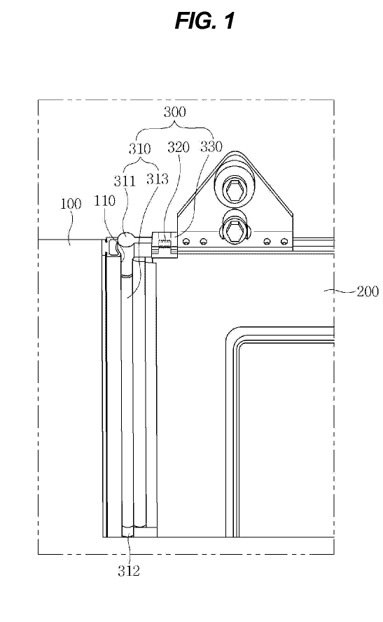

As illustrated in FIG. 1, the safety apparatus of an automatic door according to an exemplary embodiment of the present invention may be configured to include a body 100 mounted with an entrance 110, a door 200 slidably mounted on the body 100 and opening or closing the entrance 110, and a safety device 300 mounted at a side of the door 200 contacting the body 100 and preventing a passenger from being caught between the body 100 of the vehicle and the door 200.

The safety device 300 is provided with a safety part 310 mounted at a side of the door 200 contacting the body 100 so as to be slidably moved inwardly from the door 200 and an elastic part 320 mounted at a side of the door 200 and elastically supporting the safety part 310 outwardly from the door 200.

The safety part 310 is slidably mounted on an upper portion and a lower portion of the side of the door 100, respectively and includes upper and lower moving members 311 and 312 elastically supported by the elastic part 320 and a rotating member 313 horizontally rotatably mounted between the upper and lower moving members 311 and 312.

In this configuration, the rotating member 313 is formed of a cylindrical shape so as to increase a rotary power and is made of a synthetic resin having a buffer power so as to prevent a passenger from being hurt when the passenger is caught.

Meanwhile, the safety device 300 includes a return switch 330 that senses the sliding movement of the safety member 310 to again open the door 200 and further increases the safety of passengers due to the return switch 330.

An operation state of the safety apparatus of an automatic door according to the exemplary embodiment of the present invention having the above configuration will be described below.

First, when a passenger gets off and on through the entrance 110 of the body 100 configuring a bus, a driver presses a switch to operate the door 200 and closes the entrance 110 of the body 100 during the sliding movement of the door 200.

In this configuration, when a passenger gets off and on in haste before the door 200 is closed, a part of a body of a passenger or articles carried by the passenger is caught between the body 100 and the door 200. In this case, a gap is formed between the body 100 and the door 200 during the sliding movement of the safety part 310 of the safety device 300 mounted at a side of the door 200 due to a part of a body of a passenger or articles carried by the passenger and a part of a body of a passenger or articles carried by the passenger is separated between the body 100 and the door 200 through the gap to prevent an accident.

In addition, the return switch 330 senses the sliding movement of the safety part 310 to again open the door 200, thereby remarkably preventing an accident that a passenger is sandwiched between the body 100 and the door 200.

Meanwhile, when thin objects or clothes are sandwiched between the body 100 and the door 200, the sliding moving distance of the safety part 310 is short and thus, the door 200 is closed as it is. In this case, when thin objects or clothes are pulled, the thin objects or clothes may be easily separated while the rotating member 313 of the safety part 310 is rotated between the upper and lower moving members 311 and 312 to prevent the accident occurrence of a passenger.

Hereinafter, in describing another exemplary embodiment of the present invention, like components as the foregoing exemplary embodiments are denoted by like reference numerals and therefore, the overlapping description thereof will be omitted.

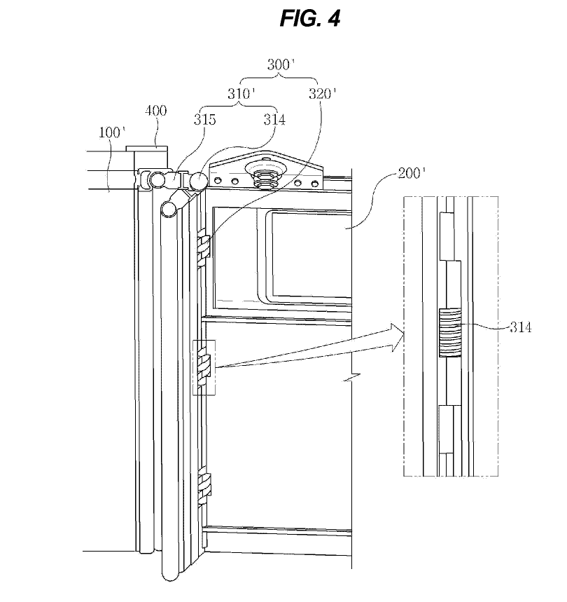

As illustrated in FIG. 4, a safety apparatus of an automatic door according to another exemplary embodiment of the present invention may be configured to include a body 100′ mounted with an entrance, a door 200′ slidably mounted on the body 100′ and opening or closing the entrance, a hinge member 314 rotatably hinged back and forth to a side of the door 200′ contacting the body 100′, a safety part 310′ formed of a contact member 315 contacting the body 100′, and a safety device 300′ mounted with an elastic part 320′ mounted on the hinge member 314 and elastically supporting the hinge member 314 against a pivotal direction of the hinge member 314.

Herein, the inside of the entrance of the body 100′ is mounted with the safety part 310′ so as not to be rotated inwardly from the entrance, and the supporting part 400 fills the gap between the body 100′ and the door 200′ at the time of the rotation of the safety part 310′ when being viewed from the indoor of the bus to increase the safety of passengers that get on the bus.

Meanwhile, the contact member 315 is formed outside the entrance further than the hinge member 314, such that the contact member 315 is more smoothly rotated, thereby increasing the safety of passengers that get on the bus.

Therefore, a safety apparatus of an automatic door according to another exemplary embodiment of the present invention can separate the safety part 310′ while forming the gap between the body 100′ and the door 200′ due to the rotation of the safety part 310′ outwardly from the bus body 100′ by pulling a part of a body of a passenger or objects when a part of a body of a passenger or objects are caught between the body 100′ and the door 200′ at the time of the closing of the door 200′, thereby preventing the accident of a passenger.

According to the exemplary embodiments of the present invention, it is possible to prevent beforehand an accident from occurring due to caught between the door and vehicle body, by using a safety apparatus that is slidably moved or rotated.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

1. A safety apparatus of an automatic door, comprising:
a body mounted with an entrance;
a door slidably mounted on the body and opening or closing the entrance; and
a safety device including a safety part slidably mounted at a side of the door and an elastic part mounted at the side of the door to elastically support the safety part,
wherein the safety part is slidably mounted on an upper portion and a lower portion of the side of the door, respectively, and includes:
upper and lower moving members slidably mounted on the side of the door and elastically supported by the elastic part; and
a rotating member rotatably mounted between the upper and lower moving members and rotatable with respect to longitudinal axes of the upper and lower moving members;
wherein the rotating member is formed of a cylindrical shape; and
wherein the rotating member is made of a synthetic resin.

2-3. (canceled)

4. The safety apparatus of the automatic door according to claim 1, wherein the safety device further includes a return switch sensing a sliding movement of the safety part to again open the door when the sliding movement of the safety part is sensed.

5-8. (canceled)
